(19) United States
(12) Patent Application Publication
(10) Pub. No.: US 2009/0299011 A1
(43) Pub. Date: Dec. 3, 2009

(54) AMPHIPHILIC COPOLYMER AND METHOD FOR FABRICATING THE SAME

(75) Inventors: Chau-Hui Wang, Kaohsiung City (TW); Chang-Hong Ho, Lunbei Township (TW); Jen-Lien Lin, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, HSINCHU (TW)

(21) Appl. No.: 12/209,189

(22) Filed: Sep. 11, 2008

(30) Foreign Application Priority Data
Jun. 2, 2008 (TW) 097120430

(51) Int. Cl. C08L 53/00

(52) U.S. Cl. 525/190

(57) ABSTRACT

An amphiphilic copolymer and method for fabricating the same are provided. Further, a polymer composition employing the amphiphilic copolymer is also provided. The amphiphilic copolymer includes a polar block connected to a nonpolar block via a moiety derived from maleic anhydride, wherein the polar block is derived from polylactide, and the nonpolar block is derived from thermoplastic polyolefin elastomer.

### CROSS REFERENCE TO RELATED APPLICATIONS

This application is based upon and claims the benefit of priority from the prior Taiwan Patent Application No. 97120430, filed on Jun. 02, 2008, the entire contents of which are incorporated herein by reference.

### BACKGROUND OF THE INVENTION

1. Field of the Invention

The invention relates to an amphiphilic copolymer and method for fabricating the same, and an amphiphilic copolymer serving as a solubilizing agent and method for fabricating the same.

2. Description of the Related Art

Thermoplastic elastomers are used extensively as the polymeric component of hot melt and pressure sensitive adhesives. In general, the elastomers are multicomponent polymers, and are molten above the glass transition temperature or melt temperature of the hard polymeric phase, and aggregated below the temperatures into domains that behave like physical crosslinks.

Polylactide (PLA) is a thermoplastic polyester serving as a regenerative biomass polymer material, and can be prepared from polymerization of lactic acid yielded from cornstarch by homofermentation. Due to superior transparency, rigidity, and UV-resistance, polylactide is the only one competitive biodegradable polymer for conventional petrochemical plastics. In comparison with polystyrene, the mechanical attributes of polylactide is equal to that of polystyrene. However, the impact resistance and toughness attributes of polylactide is worse than that of polystyrene.

In order to improve the impact resistance and toughness of polylactide and facilitate applications thereof, a conventional method comprises performing a blending of thermoplastic polyolefin elastomer (TPO) and polylactide, resulting in the introduction of soft bonds of thermoplastic polyolefin elastomer.

As used herein, the term “blending” refers to physically mixing at least two polymers to conveniently prepare a novel polymer material. The performance of the obtained novel polymer material depends on the compatibility between the at least two polymers. However, the majority of blended materials, result in phase separation. Please refer to FIG. 1, the sample bottle (a) shows that thermoplastic polyolefin elastomer (TPO) and polylactide dissolved in ethyl acetate are non-miscible resulting from phase separation, since thermoplastic polyolefin elastomer (TPO) is a non-polar polymer and polylactide is a polar polymer. Therefore, the mechanical characteristics of the obtained novel polymer are degraded.

Accordingly, it is necessary to develop a novel method to improve the intersolubility between polymers, enhancing physical and mechanical properties, to facilitate applications and mass production.

### BRIEF SUMMARY OF THE INVENTION

An exemplary embodiment of an amphiphilic copolymer comprises: a polar block derived from polylactide; and a nonpolar block derived from thermoplastic polyolefin elastomer, wherein the polar block is connected to the nonpolar block via a moiety derived from maleic anhydride. The amphiphilic copolymer can serve as a solubilizing agent for improving the intersolubility during polymer blending. The polylactide has the structure represented by formula (I).

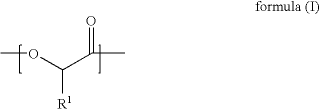

wherein, R¹ is H, CH₃, or CH₂CH₃.

The thermoplastic polyolefin elastomer comprises styrene-butadiene copolymer, ethylene-octene copolymer, ethylene-butene copolymer, ethylene-butadiene copolymer, or ethylene propylene diene monomer rubber, and the maleic anhydride has the structure represented by formula (II).

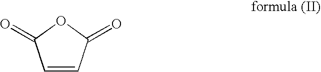

Another exemplary embodiment a method for fabricating an amphiphilic copolymer comprises: bonding a maleic anhydride to a nonpolar polymer via an initiator to prepare a nonpolar polymer with maleic anhydride branches; and reacting a polar polymer and the nonpolar polymer with maleic anhydride branches undergoing esterification in the presence of a catalyst, wherein the nonpolar polymer comprises polylactide and a nonpolar block is derived from thermoplastic polyolefin elastomer. The initiator can comprise a free-radical initiator, such as benzoyl peroxide, azobisisobutyronitrile, acetyl peroxide, t-Butyl peracetate, cumyl peroxide, t-Butyl peroxide, or t-Butyl hydroperoxide. The catalyst comprises 4-dimethylaminopyridine, triethylamine, or pyridine.

Further, in some exemplary embodiments of the invention, a composition of blended polymers is provided. The composition comprises a polar polymer; a nopolar polymer; and a solubilizing agent, wherein the solubilizing agent comprises the aforementioned amphiphilic copolymer. Particularly, the polar polymer comprises polylactide, polyglycolide, or polycaprolactone, and the polar polymer comprises thermoplastic polyolefin elastomer, polyethylene, polypropylene, or polybutadiene. The weight ratio of the solubilizing agent is 0.1-20 wt %, based on the weight of the polar and nopolar polymers.

A detailed description is given in the following embodiments with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention can be more fully understood by reading the subsequent detailed description and examples with references made to the accompanying drawings, wherein:

FIG. 1 is a photograph showing the intersolubility of sample bottle (a) and sample bottle (b).

FIG. 2 is a FT-IR spectrum of the amphiphilic copolymer prepared from Example 1.

FIG. 3a is a TEM spectrum showing the cryo-fracture surface observation of the polymer formed from composition A of Example 2.

FIG. 3b is a TEM spectrum showing the cryo-fracture surface observation of the polymer formed from composition A of Example 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Preparation of Amphiphilic Copolymer

### EXAMPLE 1

15 g ethylene-octene copolymer (serving as TPO) was dissolved in 175 ml toluene (serving as solvent). After stirring completely, 0.438 g benzoyl peroxide (BPO, serving as initiator) and 0.765 maleic anhydride (MAH) were added into the above solution, thereby obtaining TPO with maleic anhydride branches (TPO-MAH).

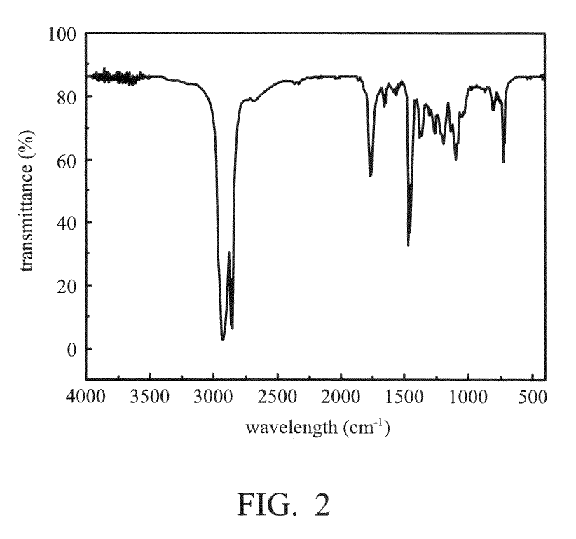

Next, 9.7 g 4-dimethylaminopyridine (DMAP, serving as catalyst), 15 g poly(D,L-lactide), and 7.5 g the obtained TPO-MAH were mixed in 100 ml toluene, and TPO-g-PLA was yielded. FIG. 2 shown a FT-IR spectrum of TPO-g-PLA prepared from Example 1. The FT-IR spectrum has a strong peak at 1764 cm-1 meaning that poly(D,L-lactide) was bonded on the ethylene-octene copolymer via maleic anhydride.

Preparation of Composition Comprising Polylactide and Thermoplastic Polyolefin Elastomer

### EXAMPLE 2

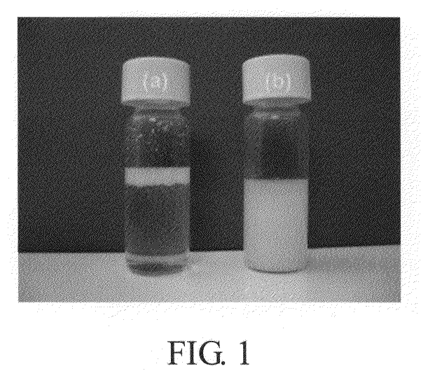

16 g poly(D,L-lactide), 4 g ethylene-octene copolymer, and 1 g TPO-g-PLA (prepared from Example 1) were dissolved in 5 ml ethyl acetate (the weight ratio of the PLA, TPO, and amphiphilic copolymer was 80:20:5), obtaining a composition A. Please refer to FIG. 1, the composition A in the sample bottle (b) formed a homogeneous phase (thermoplastic polyolefin elastomer (TPO) and polylactide were mutually soluble) since the TPO-g-PLA served as a solubilizing agent.

### EXAMPLE 3

Example 3 was performed as Example I to obtain composition (B) except for substitution of 16 g poly(D,L-lactide), and 4 g ethylene-octene copolymer for 32 g poly(D,L-lactide), and 8 g ethylene-octene copolymer. Particularly, the weight ratio between the PLA, TPO, and amphiphilic copolymer was 80:20:2.5.

### EXAMPLE 4

Example 4 was performed as Example 1 to obtain composition (B) except for substitution of 16 g poly(D,L-lactide), and 4 g ethylene-octene copolymer for 80 g poly(D,L-lactide), and 20 g ethylene-octene copolymer. Particularly, the weight ratio between the PLA, TPO, and amphiphilic copolymer was 80:20:1.

### COMPARATIVE EXAMPLE 1

8g poly(D,L-lactide) and 2 g ethylene-octene copolymer were dissolved in 5 ml ethyl acetate, obtaining composition D.

Cryo-Fracture Surface Observation

### EXAMPLE 5

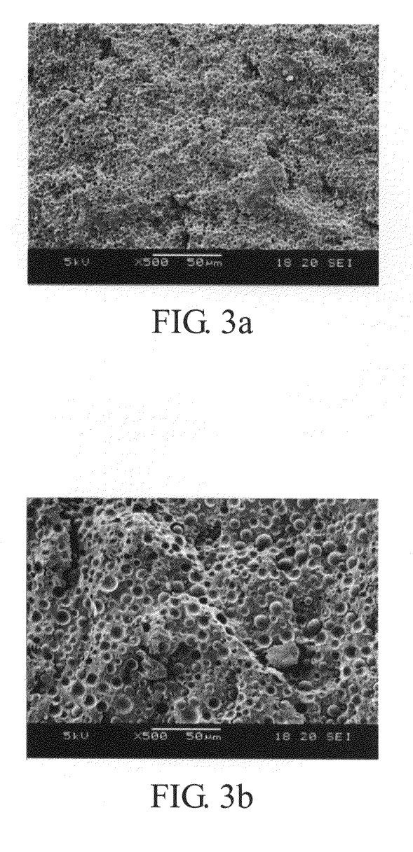

The polymers formed from composition A and composition D were respectively subjected to cryo-fracture surface observation by transmission electron microscopy (TEM), and the results were respectively shown in FIGS. 3a and 3b. As shown in FIG. 3b, the polymer formed by composition D (without TPO-g-PLA) had a dispersed particular size of 5 μm. To the contrary, as shown in FIG. 3a, the polymer formed by composition A (with TPO-g-PLA as a solubilizing agent) had a dispersed particular size of 2 μm.

Tests of Elongation at Break and Impact Resistance

### EXAMPLE 6

The polymer samples formed from poly(D,L-lactide), composition D, and composition A were respectively subjected to tests of elongation at break and impact resistance, and the results are shown in Table 1.

TABLE 1

| | elongation at break (%) | impact resistance (J/m) |
|---|---|---|
| PLA | 6.05 ± 0.58 | 73 |
| PLA/TPO(80/20) | 18.1 ± 2.78 | 137.6 |
| PLA/TPO/TPO-g-PLA | 41.9 ± 11.9 | No break |
| (80/20/5) | | |

As shown in Table. 1, the polymer formed from composition A exhibited superior impact resistance and had seven times the elongation performance of poly(D,L-lactide).

### EXAMPLE 7

The polymer samples formed from composition A, composition B, and composition C were respectively subjected to tests of elongation at break, and the results are shown in Table 2.

TABLE 2

| | elongation at break (%) |
|---|---|
| PLA/TPO/TPO-g-PLA (80/20/5) | 41.9 ± 11.9 |
| PLA/TPO/TPO-g-PLA (80/20/2.5) | 140.83 ± 17.99 |
| PLA/TPO/TPO-g-PLA (80/20/1) | 68.22 ± 20.94 |

As shown in Table. 2, the elongation of polymer formed from the composition of the invention can be modified by means of the amount of the amphiphilic copolymer. When the weight ratio of the amphiphilic copolymer was 2.5 wt %, the polymer formed from the composition comprising the amphiphilic copolymer exhibited superior elongation performance.

Accordingly, the amphiphilic copolymer serving as a solubilizing agent can be simply prepared from commercial TPO and PLA, rather than from the conventional solubilizing agent (block/branch copolymer) prepared under rigorous reaction conditions, thereby reducing cost. The intersolubility between polymers of the composition of the invention is improved and the polymer formed from the composition exhibits superior physical and mechanical properties.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An amphiphilic copolymer, comprising:
a polar block derived from polylactide; and
a nonpolar block derived from thermoplastic polyolefin elastomer,
wherein the polar block is connected to the nonpolar block via a moiety derived from maleic anhydride.

2. The amphiphilic copolymer as claimed in claim 1, wherein the polylactide has the structure represented by formula (I), of 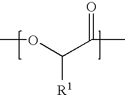
wherein, R¹ is H, CH₃, or CH₂CH₃.

3. The amphiphilic copolymer as claimed in claim 1, wherein the thermoplastic polyolefin elastomer comprises styrene-butadiene copolymer, ethylene-octene copolymer, ethylene-butene copolymer, ethylene-butadiene copolymer, or ethylene propylene diene monomer rubber.

4. The amphiphilic copolymer as claimed in claim 1, wherein the maleic anhydride has the structure represented by formula (II), of

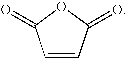

5. The amphiphilic copolymer as claimed in claim 1, wherein the amphiphilic copolymer serves as a solubilizing agent for improving the intersolubility of blended polymers.

6. A method for fabricating an amphiphilic copolymer, comprising:
bonding a maleic anhydride to a nonpolar polymer via an initiator to prepare a nonpolar polymer with maleic anhydride branches; and
reacting a polar polymer and the nonpolar polymer with maleic anhydride branches undergoing esterification in the presence of a catalyst,
wherein the nonpolar polymer comprises polylactide, and
a nonpolar block is derived from thermoplastic polyolefin elastomer.

7. The method as claimed in claim 6, wherein the polylactide has the structure represented by formula (I), of 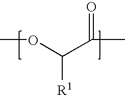
wherein, R¹ is H, CH₃, or CH₂CH₃.

8. The method as claimed in claim 6, wherein the thermoplastic polyolefin elastomer comprises styrene-butadiene copolymer, ethylene-octene copolymer, ethylene-butene copolymer, ethylene-butadiene copolymer, or ethylene propylene diene monomer rubber.

9. The method as claimed in claim 6, wherein the maleic anhydride has the structure represented by formula (II), of

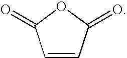

10. The method as claimed in claim 6, wherein the initiator comprises a free-radical initiator.

11. The method as claimed in claim 6, wherein the initiator comprises benzoyl peroxide, azobisisobutyronitrile, acetyl peroxide, t-Butyl peracetate, cumyl peroxide, t-Butyl peroxide, or t-Butyl hydroperoxide.

12. The method as claimed in claim 6, wherein the catalyst comprises 4-dimethylaminopyridine, triethylamine, or pyridine.

13. A composition, comprising:
a polar polymer;
a nopolar polymer; and
a solubilizing agent, wherein the solubilizing agent comprises the amphiphilic copolymer as claimed in claim 1.

14. The composition as claimed in claim 13, wherein the polar polymer comprises polylactide, polyglycolide, or polycaprolactone.

15. The composition as claimed in claim 13, wherein the polylactide has the structure represented by formula (I), of 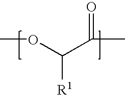
wherein, R¹ is H, CH₃, or CH₂CH₃.

16. The composition as claimed in claim 13, wherein the polar polymer comprises thermoplastic polyolefin elastomer, polyethylene, polypropylene, or polybutadiene.

17. The composition as claimed in claim 16, wherein the thermoplastic polyolefin elastomer comprises styrene-butadiene copolymer, ethylene-octene copolymer, ethylene-butene copolymer, ethylene-butadiene copolymer, or ethylene propylene diene monomer rubber.

18. The composition as claimed in claim 16, wherein the weight ratio of the solubilizing agent is 0.1-20 wt %, based on the weight of the polar and nopolar polymers.
